(19) United States
(12) Patent Application Publication
(10) Pub. No.: US 2003/0120591 A1
(43) Pub. Date: Jun. 26, 2003

(54) Systems and methods for facilitating responses to credit requests

(76) Inventors: Mark Birkhead, Stamford, CT (US); Ken Huber, Atlanta, GA (US); Diane Hill Siani, Roswell, GA (US)

Correspondence Address: BUCKLEY, MASCHOFF, TALWALKAR, & ALLISON, 5 ELM STREET, NEW CANAAN, CT, 06840, US

(21) Appl. No.: 10/026,101

(22) Filed: Dec. 21, 2001

(51) Int. Cl. G06F 17/60

(52) U.S. Cl. 705/39

(57) ABSTRACT

Systems and methods are disclosed to facilitate responses to credit requests. According to one embodiment, information associated with a credit request is received from a customer. For example, information may be received from a customer via a customer service representative located at a telephone call center. Income information associated with the customer is then estimated. For example, a credit rating service may estimate the customer's income based on an existing mortgage loan. The estimated income is then used to provide the customer with a response to his or her request in substantially real time. For example, the customer service representative may provide the response to the customer via the telephone call.

### FIELD

The present invention relates to credit requests. In particular, the present invention relates to systems and methods for facilitating responses to credit requests.

### BACKGROUND

A customer having a credit card account is often interested in increasing the amount of credit that is available through that account. For example, a customer may have a credit card account with a limit of $5,000 and a current outstanding balance of $4,700. If the customer is interested in using the account to purchase a $500 item, he or she may ask to have the credit limit increased to $5,200.

Such a request may initially be handled by a customer service representative at a telephone call center. The customer service representative may, for example, ask the customer for his or her name, credit card number, and the amount of credit he or she would like to receive. Typically, the customer's request is then manually reviewed by another employee or “underwriter” associated with the credit card company. The underwriter may, for example, review information associated with the customer and/or the credit card account (e.g., by accessing information from a credit rating service and completing a MICROSOFT® EXCEL worksheet) to determine if the request will be approved.

Unfortunately, such an approach can be time consuming. For example, the underwriter may need to verify the customers current income by asking the customer to submit a copy of a tax return or pay stub via facsimile or postal mail. Only after the customer's income is verified will underwriter decide whether or not the customer's request will be approved. This type of delay may be inconvenient for customers (who may need to immediately purchase an item) and can even frustrate customer service representatives (who are unable to help the customer during the initial telephone call).

The typical approach also has other disadvantages. For example, receiving information from a third-party credit rating service can itself be time consuming. Moreover, the credit rating service may charge a fee each time information about a customer is retrieved. These fees will be particularly important if a large number of credit requests need to be processed. Another disadvantage is that an underwriter might mistakenly enter information or provide an incorrect response to a request.

Even if some or all of the decision making process were automated, a customer might be disappointed or offended if a request is automatically denied (e.g., because of a problem with the customer's credit rating). Such results can unfortunately lead to problems with important customers (e.g., a customer who already has a significant amount of credit).

### SUMMARY

To alleviate problems inherent in the prior art, the present invention introduces systems and methods for facilitating responses to credit requests.

According to one embodiment, information associated with a credit request is received via a customer service representative. Income information associated with the customer is estimated, and it is arranged for the customer to receive a response to the credit request in substantially real time.

According to another embodiment, information associated with a request for an increased credit limit is received via a telephone call between a customer and a customer service representative. Credit request information is automatically transmitted from a customer service representative device to a credit rating service device via a communication network, and a response is received from the credit rating service device, the response being based on an estimated income determined in accordance with mortgage information associated with the customer. The response is then provided to the customer in substantially real time via the telephone call.

According to still another embodiment, information associated with a customer's credit request is received, and a response to the credit request is automatically generated. If the automatically generated response to the credit request is not an approval, it is then determined if the response to the credit request will be a referral.

According to yet another embodiment, information associated with a credit request is received from a customer. It is then locally determined if a response to the credit request is a denial. If it is not determined that the response is a denial, information is automatically transmitted to a credit rating service device, and a response is received from the credit rating service device based on credit rating information. The response is then provided to the customer in substantially real time.

One embodiment comprises: means for receiving via a customer service representative information associated with a customer's credit request; means for estimating income information associated with the customer; and means for arranging for the customer to receive a response to the credit request in substantially real time.

Another embodiment comprises: means for receiving information associated with a request for an increased credit limit via a telephone call between a customer and a customer service representative; means for automatically transmitting credit request information from a customer service representative device to a credit rating service device via a communication network; means for receiving a response from the credit rating service device, the response being based on an estimated income determined in accordance with mortgage information associated with the customer; and means for providing the response to the customer in substantially real time via the telephone call.

Still another embodiment comprises: means for receiving information associated with a customer's credit request; means for automatically generating a response to the credit request; and means for determining if the response to the credit request will be a referral if the automatically generated response to the credit request is not an approval.

Yet another embodiment comprises: means for receiving from a customer information associated with a credit request; means for locally determining if a response to the credit request is a denial; means for automatically transmitting information to a credit rating service device; means for receiving a response to the credit request based on credit rating information; and means for providing the response to the customer in substantially real time.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a credit request system according to some embodiments of the present invention.

FIG. 2 is an information flow diagram according to some embodiments of the present invention.

FIG. 3 is a flow chart of a method according to some embodiments of the present invention.

FIG. 4 illustrates a credit request display according to one embodiment of the present invention.

FIG. 5 is a flow chart of a method according to some embodiments of the present invention.

FIG. 6 is a flow chart of a method according to some embodiments of the present invention.

FIG. 7 is a block diagram overview of a credit request device according to an embodiment of the present invention.

FIG. 8 is a tabular representation of a portion of a customer database according to an embodiment of the present invention.

FIG. 9 is a tabular representation of a portion of a credit request database according to an embodiment of the present invention.

FIG. 10 is a flow chart of a computer-implemented method according to some embodiments of the present invention.

### DETAILED DESCRIPTION

Embodiments of the present invention are directed to systems and methods for facilitating responses to “credit requests.” As used herein, a credit request may be any request received from a customer associated with credit that has been, or may be, made available to a customer. A credit request may be, for example, a request to increase an amount of credit associated with the customer's credit card account.

Credit Request System

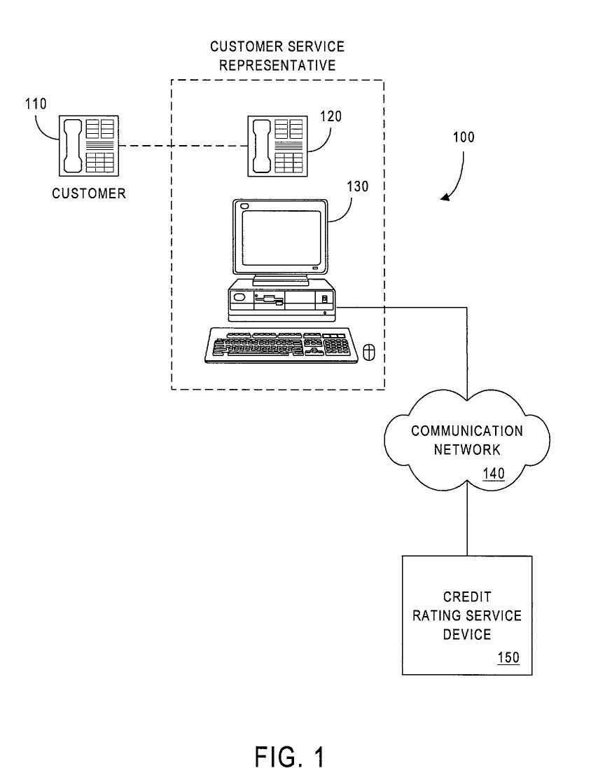

Turning now in detail to the drawings, FIG. 1 is a block diagram of a credit request system 100 according to some embodiments of the present invention. The credit request system 100 includes a telephone 120 and Personal Computer (PC) 130 associated with a customer service representative. The customer service representative may, for example, be located at a credit card telephone call center.

The customer service representative uses the telephone 120 to receive a telephone call from a customer's telephone 110. The PC 130 is used by the customer service representative to exchange information with a credit rating service device 150 via a communication network 140. The credit rating service device 150 may be associated with, for example, EQUIFAX, INC.®

The communication network 140 may be, for example, a proprietary network, a Local Area Network (LAN), a Metropolitan Area Network (MAN), a Wide Area Network (WAN), a Public Switched Telephone Network (PSTN), a Wireless Application Protocol (WAP) network, or an Internet Protocol (IP) network such as the Internet, an intranet or an extranet. According to one embodiment, the credit rating service device 150 includes a Web server and the PC 130 is adapted to run a Web browser application (e.g., the INTERNET EXPLORER® application available from MICROSOFT®)).

Note that the customer service representative PC 130 does not need to communicate with the credit rating service device 150 directly. For example, the customer service representative PC 130 may communicate with a local server, which in turn communicates with the credit rating service device 150.

Also note that the devices shown in FIG. 1 need not be in constant communication. For example, the customer service representative's PC 130 a may communicate with the credit rating service device 150 on an as-needed basis. Moreover, although a single customer telephone 110, customer service representative telephone 120, PC 130, and credit rating service device 150 are shown in FIG. 1, any number of these devices may be included in the credit request system 100. Similarly, several of the devices shown in FIG. 1 may be incorporated into a single device (e.g., a single device may act as both the customer service representative telephone 120 and PC 130).

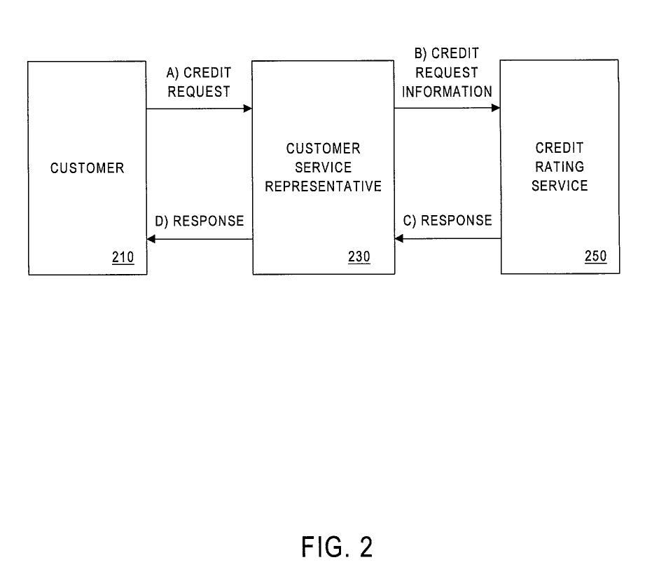

According an embodiment of the present invention, the credit request system 100 facilitates responses to credit requests. In particular, FIG. 2 is an information flow diagram according to some embodiments of the present invention. At (A), a customer 210 submits a credit request to a customer service representative 230. For example, the customer 210 may place a telephone call to the customer service representative 230 and request an increase in a credit limit associated with his or her credit card account.

At (B), credit request information is transmitted from the customer service representative 230 to a credit rating service 250, and the customer service representative 230 receives a response from the credit rating service 250 at (C). The customer service representative 230 then provides the response to the customer at (D). For example, the customer service representative 230 may inform the customer that his or her request has been approved or denied via the telephone call.

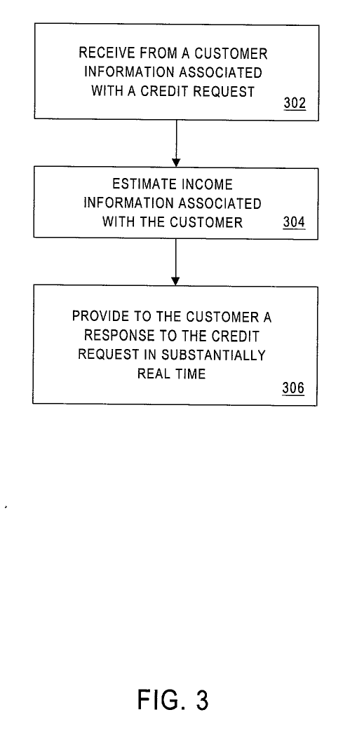

Several methods that may be performed in accordance with some embodiments of the present invention will now be described with respect to FIGS. 3 through 6.

Credit Request Methods

FIG. 3 is a flow chart of a method that may be performed, for example, via the credit request system 100 according to some embodiments of the present invention. The flow charts in FIG. 3 and the other figures described herein do not imply a fixed order to the steps, and embodiments of the present invention can be practiced in any order that is practicable. Also not that different steps described in a single flowchart may be performed by different devices.

At 302, information associated with a credit request is received from a customer. The credit request may be, for example, a credit limit increase request that includes a customer name and/or identifier (e.g., a credit card account number or a Social Security number). The credit request may also include a requested credit limit (e.g., the customer may ask to have his or her credit limit increased from $2,500 to $4,000) and information about a potential transaction (e.g., a product or purpose identifier associated with a potential transaction). According to some embodiments, the customer also provides a stated income level that might be used to evaluate his or her credit request.

The credit request may be received, for example, via a telephone call from the customer. That is, the credit request may be received by a customer service representative who uses a PC to forward information about the request to a credit rating service 150.

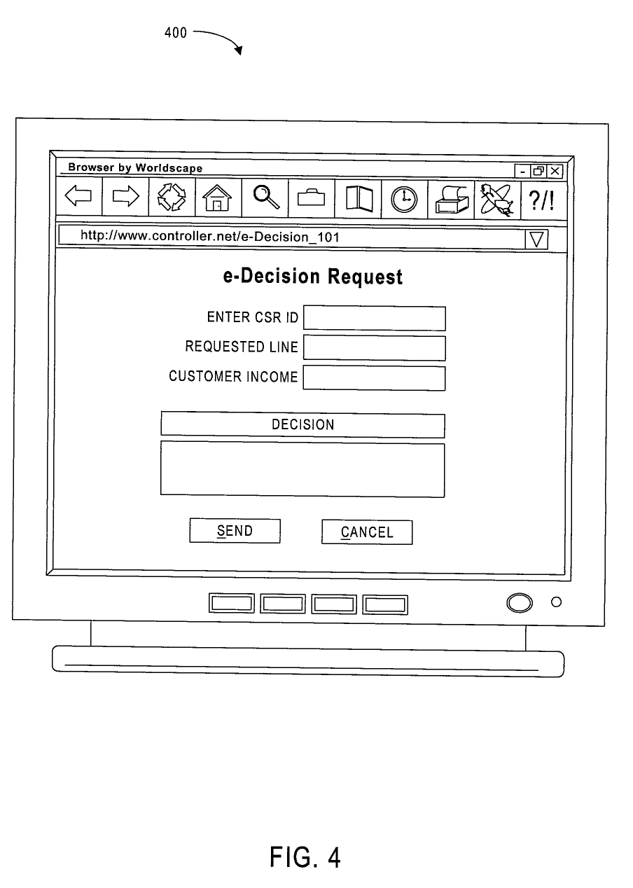

By way of example, FIG. 4 illustrates a credit request display 400 according to one embodiment of the present invention. As can be seen, a customer service representative may use the credit request display 400 to enter an identifier (e.g., his or her password), a requested amount of credit (a “requested line”), and the customer's stated income (“customer income”). The customer service representative can then activate the “send” icon to transmit the information to a local server or credit rating service device 150.

At 304, income information associated with the customer is estimated. For example, mortgage information associated with the customer may be determined by a credit rating service (e.g., it may be determined that customer has a $200,000 mortgage on his or her home). The mortgage information may then be used to estimate the customer's income (e.g., people who have a $200,000 mortgage may typically have incomes of at least $50,000 per year). The estimation may be based on, for example, a formula or a table of mortgage values and associated yearly incomes.

The mortgage information may be determined, for example, by initially transmitting information to a credit rating service device 150 (e.g., the customer's name and Social Security number may be automatically determined based on a credit card number and transmitted to the credit rating service device 150). The credit rating service device 150 can then retrieve the appropriate mortgage information (e.g., from a database).

According to some embodiments, the estimated income information is compared with the customer's stated income. For example, if the customer stated that he or she has a yearly income of $40,000—and the estimated income for that customer is within a pre-determined range of that value—the customer's credit request may be approved (e.g., assuming no other problems with the request were uncovered).

The response to customer's credit request may be, for example, an approval or a denial. According to one embodiment, the response may instead be a counter-offer. For example, if a customer asks to have his or her credit limit increased from $1,500 to $2,000 a customer service representative may respond that the credit limit can only be increased to $1,750. Another type of response that might be provided to the customer is a “referral” to another party, such as an underwriter, who will personally review and discuss the request with the customer.

In addition to the customer's stated income level and the estimated income, the response to the customer's credit request may be based other information determined by, or received via, the credit rating service device 150. Such information may include, for example, a customer name, a customer identifier (e.g., a credit card number or a Social Security number), a current credit limit, and a requested credit limit. The information may also include a product or purpose identifier (e.g., a credit request associated with a home improvement purchase might be approved while a similar request associated with a luxury cruise ticket would be denied). Other factors that might be used to determine the response include an account open date (e.g., a request associated with a longstanding account may be more likely to be approved), a current account balance, an account source (e.g., mail or facsimile), an indication of home ownership, a last billing date, a delinquency status or profile, information associated with a prior credit limit increase request, information associated with a prior payment, a performance score, and a non-prime score. Still other factors might include trade information (e.g., indicating a number of trades that were past due at least thirty days during the past twelve months), inquiry information (e.g., indications that other parties have inquired about the customer's credit), bankruptcy information, lien information, collection information, an indication that the customer is deceased, and debt information.

Some of the information associated with the credit request may be used as “a knock-out criteria.” For example, any credit request from a customer who is currently delinquent in connection with the credit card account might automatically be denied (e.g., regardless of other information). The information may also be used to determine a credit grade or score (e.g., a score from one through fifteen indicating an amount of credit that can be extended to the customer). According to another embodiment, information is used in accordance with a set of pre-determined decision or strategy paths. For example, one decision path may apply to a customer who owns a home while another path applies to a customer who rents an apartment. According to one embodiment, such decision logic is associated with FAIR, ISAAC® and/or TRIAD® credit line strategy optimization technology.

Other information can also be retrieved, received or calculated to determine a response to the credit request, such as a debt to income ratio value, a disposable income value, a maximum percentage (e.g., a credit limit increase may be limited to 20% of the current balance), a maximum amount (e.g., a credit limit increase may be limited to $1,000), a pad amount (e.g., an extra $100 may be added to all credit limit increases), and a rounding amount (e.g., a credit limit increase may rounded to the nearest $50).

At 306, the customer is provided with the response in substantially real time. For example, the customer service representative may provide the response to the customer via the telephone call within ten seconds. In this way, the customer can quickly receive and use the credit limit increase (e.g., without having to provide a copy of his or her tax return) and the risk of approving a credit limit increase to a customer with insufficient income can be reduced (e.g., because his or her income has been estimated in substantially real time via the mortgage information).

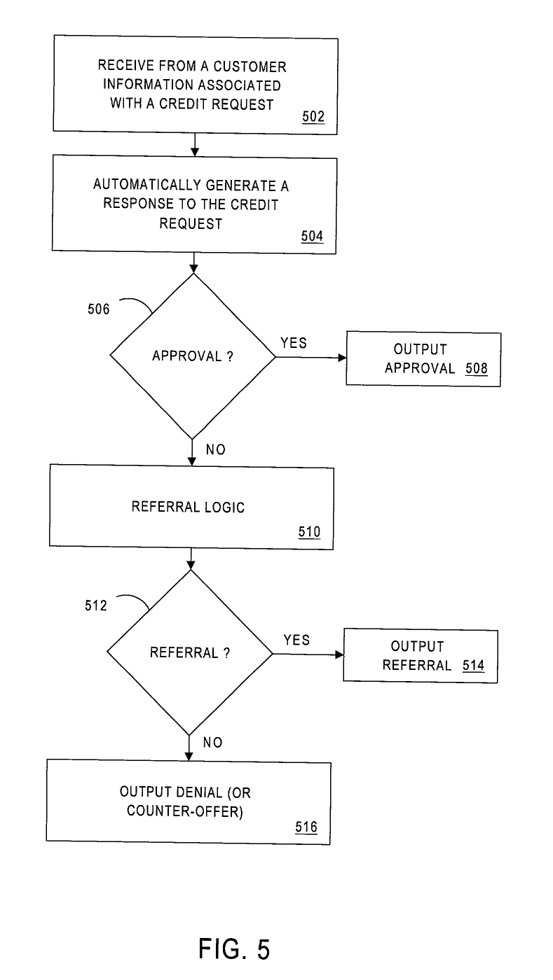

FIG. 5 is a flow chart of a method according to still another embodiment of the present invention. At 502 information associated with a credit request is received from a customer, and a response to the credit request is automatically generated at 504. These steps may be performed, for example, as described with respect to FIG. 3.

If the automatically generated response is an approval at 506, the approval is provided to the customer at 508. For example, a customer service representative may verbally indicate to the customer that his or her request has been approved.

If the response is not an approval at 506, however, referral logic is executed at 510. That is, it is determined if the customer's request should be further considered or otherwise handled, such as by an underwriter.

If the referral logic indicates that a referral is necessary at 512, the customer is provided with referral information at 514 (e.g., the customer's telephone call may be transferred to the underwriter). The underwriter might then determine that the response should, in fact, be an approval or simply explain the reasons for a denial to the customer. Such referrals may be appropriate, for example, for particularly important customers (e.g., longstanding customers or customers who already have a significant amount of credit).

If the referral logic indicates that a referral is not necessary at 512, a denial is simply provided to the customer at 516. In this way, the risk of offending or disappointing important customers can be reduced without having an underwriter review each and every denial (e.g., including those associated with less important customers).

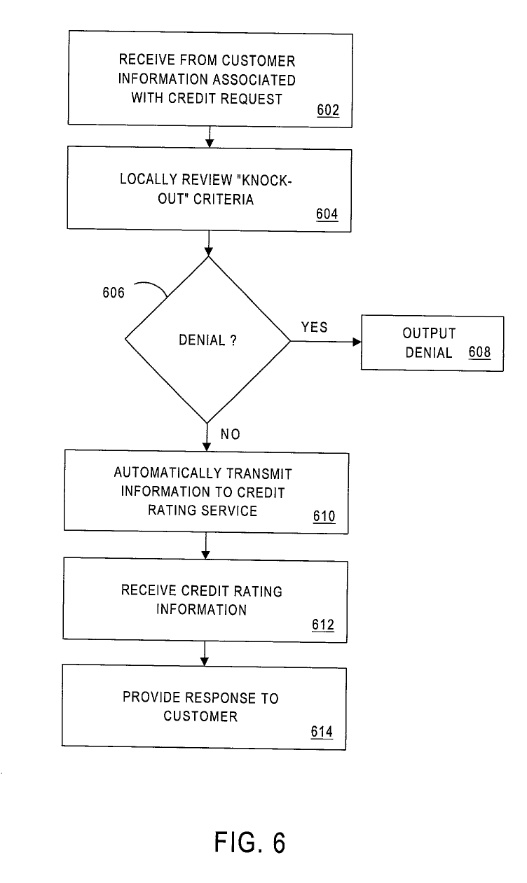

FIG. 6 is a flow chart of a method according to yet another embodiment of the present invention. At 602, information associated with a credit request is received from a customer. For example, the customer may request a credit limit increase via a telephone call to a customer representative.

One or more “knock-out” criteria are then locally reviewed at 604 (e.g., by a sever associated with the telephone call center). That is, information about the customer may be retrieved from a local database (e.g., the information does not need to be received from a credit rating service device 150). For example, it may be locally determined if the customer is currently delinquent with respect to his or her credit card account.

If the result of the knock-out criteria review is a denial at 606, the denial is provided to the customer at 608. If the result is not a denial at 606, information is then automatically transmitted to a credit rating service at 610. For example, the customer's name and Social Security number may be automatically retrieved from a local database and transmitted to the credit rating service. Credit rating information (such as a simple “approval” or “denial”) is then received from the credit rating service at 612, and a response is provided to the customer at 614. For example, the credit rating service may generate a credit score associated with the customer's credit history, A response may then be determined based on the score and provided to customer.

### EXAMPLE

Consider Alice, who has a credit card account with a current limit of $3,000 and a current outstanding balance of $2,600. She is interested in purchasing new carpet costing $625 using her credit card account. Because this purchase would exceed her current credit limit, Alice calls to a telephone call center and requests a credit limit increase. A customer service representative asks Alice to provide: (i) her credit card number, (ii) the amount of increase she desires, (iii) a description of the items or services she wants to purchase with the increase, and (iv) her yearly income. Alice answers these questions, indicating that her yearly income is $45,000, and the customer service representative enters the information into a PC.

After determining that Alice is not delinquent in her credit card account payments, a server located at the telephone call center determines Alice's Social Security number (e.g., via a locally stored database) and transmits that information to a credit rating service. The credit rating service determines information about Alice's credit history, including the fact that she has a $180,000 mortgage loan.

Based on her $180,000 mortgage loan, the credit rating service estimates that Alice's yearly income is most likely between $40,000 and $60,000. Because this estimate is consistent with her stated income (and because no other risk factors were detected), the customer service representative's PC displays a message indicating that Alice's credit limit request has been approved. The customer service representative then relays the approval to Alice in substantially real time (e.g., fifteen seconds after the information is entered into the customer service representative's PC). Note that Alice's credit limit may actually be increased by an amount greater than she requested (i.e., $2,600+625=$3,225). For example, her credit limit may now be $3,500 due to padding and/or rounding functions associated with the credit limit increase.

As another example, Bob has a credit card account with a current limit of $150,000 and a current outstanding balance of $144,000. He is interested in purchasing first class airline tickets costing $8,500 using his credit card account. Because this purchase would exceed his current credit limit, Bob calls a telephone call center and requests a credit limit increase. A customer service representative asks Bob to provide: (i) his credit card number, (ii) the amount of increase he desires, and (iii) a description of the items or services he wants to purchase with the increase.

Bob answers these questions, and the customer service representative enters the information into a PC. Since the increase will be used to purchase first class airline tickets, the system determines that Bob's request will not be automatically approved. Before providing that indication to Bob, however, the system executes logic to determine if Bob's request will be handled by an underwriter. Because Bob has been a good customer for five years, and in view of the substantial amount of credit associated with his account, the logic determines that Bob's request should be handled by an underwriter. The customer service representative then transfers Bob's telephone call to the underwriter (who may determine that the credit limit increase can be approved or otherwise handle Bob's request).

Credit Request Device

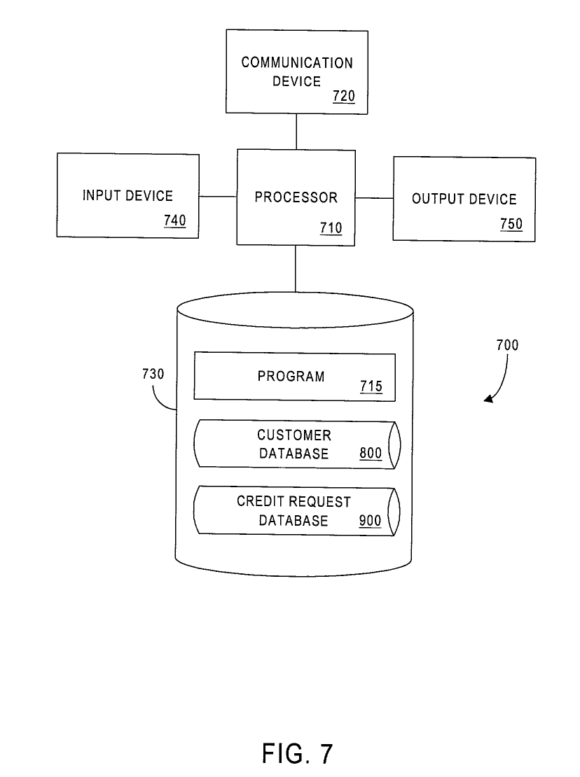

FIG. 7 illustrates a credit request device 700 that maybe associated with one or more devices shown in FIG. 1 according to some embodiments of the present invention. The credit request device 700 includes a processor 710, such as one or more INTEL® Pentium® processors. The processor 710 is coupled to a communication device 720 that may be used, for example, to communicate with one or more customer service representative PCs 130, credit rating service devices 150, or other credit request devices 700.

The processor 710 is also in communication with an input device 740. The input device 740 may comprise, for example, a keyboard, a mouse or other pointing device, and/or a microphone. Such an input device 740 may be used, for example, to enter information about a customer or a credit request.

The processor 710 is also in communication with an output device 750. The output device 750 may comprise, for example, a display (e.g., a computer monitor), a speaker, and/or a printer. The output device 750 may be used, for example, to display or otherwise provide information about a customer or a credit request (e.g., a response to a credit request).

The processor 710 is also in communication with a storage device 730. The storage device 730 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 730 stores a program 715 for controlling the processor 710. The processor 710 performs instructions of the program 715, and thereby operates in accordance with the present invention. For example, the processor 710 may receive information associated with a customer's credit request (e.g., from a customer service representative device). The processor 710 then estimates income information associated with the customer and arranges for the customer to receive a response to the credit request in substantially real time.

According to still another embodiment, the processor 710 receives information associated with a customer's credit request. The processor 710 then automatically generates a response to the credit request. If the automatically generated response to the credit request is not an approval, the processor 710 determines if the response to the credit request will be a referral.

According to yet another embodiment, the processor 710 receives information associated with a credit request from a customer and locally determines if a response to the credit request is a denial. If it is not determined that the response is a denial, the processor 710 automatically transmits information to a credit rating service device and receives a response based on the credit rating information. The processor 710 also arranges for the customer to receive the response in substantially real time.

As used herein, information may be “received” by or “transmitted” to the credit request device 700, a software application within the credit request device 700, and/or any other source.

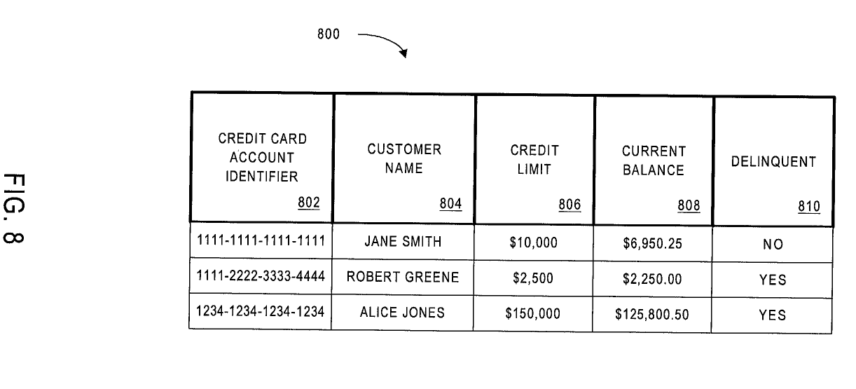

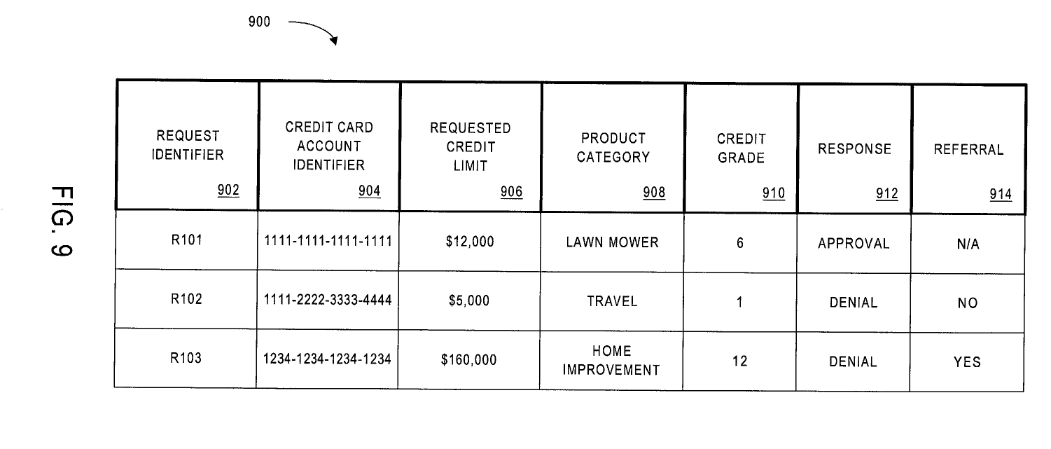

As shown in FIG. 7, the storage device 730 also stores a customer database 800 (described with respect to FIG. 8) and an credit request database 900 (described with respect to FIG. 9). Examples of databases that may be used in connection with the credit request device 700 will now be described in detail. The illustrations and accompanying descriptions of the databases presented herein are exemplary, and any number of other database arrangements could be employed besides those suggested by the figures.

Customer Database

Referring to FIG. 8, a table represents a portion of the customer database 800 that may be stored, for example, at a customer service representative device (e.g., a PC 130 or local server), a credit rating service device 150, and/or a credit request device 700. The table includes entries identifying customers who may submit credit requests via the credit request system 100. The table also defines fields 802, 804, 806, 808, 810 for each of the entries. The fields specify: a credit card account identifier 802, a customer identifier 804, a credit limit 806, a current balance 808, and a delinquency indication 810. The information in the customer database 800 may be created and updated, for example, when a customer establishes a credit card account and/or when credit card account transactions are processed (e.g., purchases and payments).

The credit card account identifier 802 may be, for example, a credit card number associated with the customer's credit card account. The customer name 804 and the credit limit 806 indicate his or her name and the total amount of credit that is currently available through the account, respectively. The current balance 808 indicates how much of the customer's credit limit 806 has already been used. For example, as illustrated by the second entry in FIG. 8, Robert Greene has used $2,250 of his $2,500 credit limit (i.e., only $250 of credit is still available). The delinquency indication 810 indicates whether or not the customer is currently behind in his or her credit card payments.

Credit Request Database

Referring to FIG. 9, a table represents a portion of the credit request database 900 that may be stored, for example, at a customer service representative device (e.g., a PC 130 or local server), a credit rating service device 150, and/or a credit request device 700. The table includes entries associated with credit requests processed via the credit request system 100. The table also defines fields 902, 904, 906, 908, 910, 912, 914 for each of the entries. The fields specify: a request identifier 902, a credit card account identifier 904, a requested credit limit 906, a product category 908, a credit grade 910, a response 912, and a referral status 914. The information in the credit request database 900 may be created and updated, for example, when a customer submits a request and/or receives a response via the credit request system 100.

The request identifier 902 identifier may be an alphanumeric code associated with a credit request received from a customer via the credit request system 100. The credit card account identifier 904 may be based on, or associated with, the credit card account identifier 802 stored in the customer database 800.

The requested credit limit 906 indicates the amount of credit being requested by the customer. The product category 908 may reflect, for example, items or services that the customer is interested in purchasing with increased credit limit.

The credit grade 910 may comprise, for example, a score or other rating associated with the customer's credit history. The response 912 may indicate, for example, whether or not the customer's request has been approved. Note that the credit grade 910 and/or the response 912 may be based on, for example, information retrieved or determined by a credit rating service. The referral status 914 indicates whether or not the customer's request will be further reviewed or otherwise handled by an underwriter.

Additional Credit Request Method

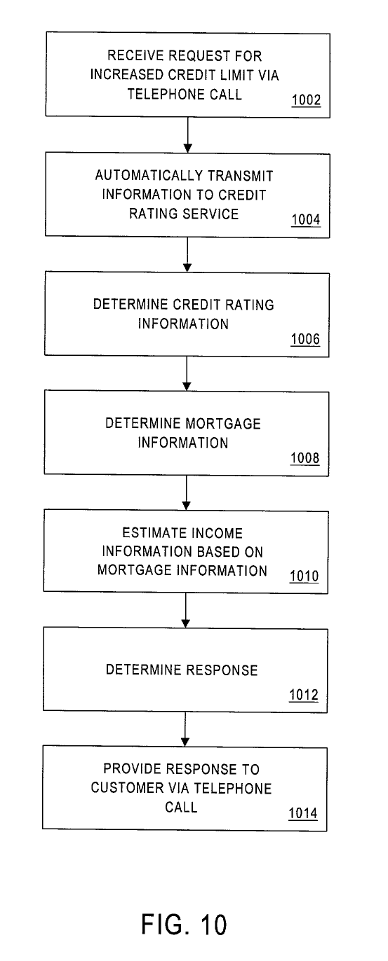

FIG. 10 is a flow chart of a computer-implemented method of facilitating responses to requests for increased credit limits according to some embodiments of the present invention. The method may be performed, for example, by a customer service representative device (e.g., a PC 130 or local server), a credit rating service device 150, and/or a credit request device 700. At 1002, a request for an increased credit limit is received from a customer via a telephone call. For example, a customer may call a telephone call center and provide to a customer service representative his or her credit card number, a requested amount of credit, and an item or service to be purchased with the increased credit. The credit card account number 904, requested credit limit 906, and product category 908 may then be stored in the credit request database 900 as appropriate.

Information is then automatically transmitted to a credit rating service at 1004. For example, the information entered by the customer service representative may be transmitted from the PC 130 to the credit rating service device 150 via the Internet. According to another embodiment, a local server retrieves the customer name 804 and credit limit 806 from the customer database 800 and transmits that information to the credit rating service device 150.

At 1006, credit rating information is determined. For example, the credit rating service device 150 may retrieve information about the customer's credit history from a database (or from yet another service) and update the customer's credit grade 910 as appropriate. Mortgage information associated with the customer is also determined at 1008 and used to estimate income information at 1010. For example, the credit rating service device 150 may determine that the customer has a mortgage loan of $210,000 and, based on that value, estimate that the customer's yearly income is between $45,000 and $65,000.

A response to the customer request is then determined at 1012. The response may be based on, for example, a knock-out criteria, a strategy path, and/or the credit grade 910. According to one embodiment, the credit rating service device 150 also compares the estimated income with a stated income that was provided by the customer (e.g., and was in turn transmitted from the PC 130 to the credit rating service device 150). The response 912 is then updated in the credit request database 900 as appropriate.

The response is then provided to the customer at 1014. For example, the response may be transmitted from the credit rating service device 150 to the customer service representative PC 130. The customer service representative can then verbally provide the response to the customer over the telephone.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although certain embodiments have been described with respect to credit requests that are received directly from customers, according to another embodiment some or all of the information is instead received from a merchant or merchant device. For example, a customer may indicate to a merchant that he or she is interested in purchasing an item. The merchant may then transmit information about the purchase to a credit card company (e.g., where, in turn, it is recognized that a credit limit increase will be required to approve the purchase).

Moreover, embodiments have been described with respect to credit requests that are received from customers via telephone calls. According to other embodiments, however, such requests can instead be received, for example, via electronic messages, such as e-mail messages or information exchanged via Web sites.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating responses to credit requests, comprising:
receiving via a customer service representative information associated with a customer's credit request;
estimating income information associated with the customer; and
arranging for the customer to receive a response to the credit request in substantially real time.

2. The method of claim 1, wherein the credit request is a credit limit increase request.

3. The method of claim 1, wherein said receiving and arranging are associated with a telephone call between the customer and the customer service representative.

4. The method of claim 1, wherein the response to the credit request is at least one of: (i) an approval, (ii) a denial, (iii) a counter-offer, and (iv) a referral.

5. The method of claim 1, wherein said estimating comprises:
determining mortgage information associated with the customer; and
estimating the income information based on the mortgage information.

6. The method of claim 5, wherein the customer information includes a stated income level and further comprising:
verifying the stated income level based on the estimated income information.

7. The method of claim 1, wherein said receiving is performed by a credit rating service device and comprises:
receiving the information from a customer service representative device.

8. The method of claim 1, further comprising:
determining the response to the credit request.

9. The method of claim 8, wherein said determining is performed via at least one of: (i) a knock-out criteria, (ii) a strategy path, and (iii) a credit grade.

10. The method of claim 8, wherein said determining is based on at least one of: (i) a debt to income ratio, (ii) a calculated disposable income, (iii) a maximum percentage, (iv) a maximum amount, (v) a pad amount, and (vi) a rounding amount.

11. The method of claim 8, wherein the received information includes at least one of: (i) a customer name, (ii) a customer identifier, (iii) a credit card account number, (iv) a requested credit limit, (v) a stated income level, (vi) a Social Security number, (vii) a product identifier, and (viii) a purpose identifier.

12. The method of claim 8, wherein said determining is performed by a credit rating service device and is based on at least one of: (i) a customer name, (ii) a customer identifier, (iii) a credit card account number, (iv) a current credit limit, (v) a requested credit limit, (vi) a stated income level, (vii) a Social Security number, (viii) a product identifier, (ix) a purpose identifier, (x) an account open date, (xi) an account balance, (xii) an account source, (xiii) an indication of home ownership, (xiv) a last billing date, (xv) a delinquency status, (xvi) a delinquency profile, (xvii) information associated with a prior credit limit increase request, (xviii) information associated with a prior payment, (xix) a performance score, and (xx) a non-prime score.

13. The method of claim 8, wherein said determining is performed by a credit rating service device and is based on at least one of: (i) trade information, (ii) inquiry information, (iii) bankruptcy information, (iv) lien information, (v) collection information, (vi) an indication that the customer is deceased, and (vii) debt information.

14. The method of claim 1, wherein said arranging comprises:
automatically transmitting a response from a credit rating service device to a customer service representative device.

15. The method of claim 14, wherein the response is transmitted via a communication network.

16. The method of claim 15, wherein the information associated with the customer's credit request is received via the communication network.

17. The method of claim 15, wherein the customer service representative device comprises a personal computer, the credit rating service device comprises a server, and the communication network comprises at least one of: (i) an Internet protocol network, (ii) the Internet, (iii) a public network, (iv) a proprietary network, and (v) a wireless network.

18. An apparatus, comprising:
a processor; and
a storage device in communication with said processor and storing instructions adapted to be executed by said processor to:
receive via a customer service representative information associated with a customer's credit request,
estimate income information associated with the customer, and
arrange for the customer to receive a response to the credit request in substantially real time.

19. The apparatus of claim 18, wherein said storage device further stores at least one of: (i) a customer database, and (ii) a credit request database.

20. The apparatus of claim 18, further comprising:
a communication device coupled to said processor and adapted to communicate with at least one of: (i) a customer device, (ii) a customer service representative device, (iii) a customer rating service device, and (iv) a credit request device.

21. A medium storing instructions adapted to be executed by a processor to perform a method of facilitating responses to credit requests, said method comprising:
receiving via a customer service representative information associated with a customer's credit request;
estimating income information associated with the customer; and
arranging for the customer to receive a response to the credit request in substantially real time.

22. A computer-implemented method of facilitating responses to requests for increased credit limits, comprising:
receiving information associated with a request for an increased credit limit via a telephone call between a customer and a customer service representative;
automatically transmitting credit request information from a customer service representative device to a credit rating service device via a communication network;
receiving a response from the credit rating service device, the response being based on an estimated income determined in accordance with mortgage information associated with the customer; and
providing the response to the customer in substantially real time via the telephone call.

23. A method of facilitating responses to credit requests, comprising:
receiving information associated with a customer's credit request;
automatically generating a response to the credit request; and
if the automatically generated response to the credit request is not an approval, determining if the response to the credit request will be a referral.

24. A method of facilitating responses to credit requests, comprising:
receiving from a customer information associated with a credit request;
locally determining if a response to the credit request is a denial; and
if it is not determined that the response is a denial:
automatically transmitting information to a credit rating service device, and
receiving a response to the credit request based on credit rating information; and
providing the response to the customer in substantially real time.
